(19) United States
(12) Patent Application Publication
(10) Pub. No.: US 2009/0076797 A1
(43) Pub. Date: Mar. 19, 2009

(54) System and Method For Accessing Images With A Novel User Interface And Natural Language Processing

(76) Inventor: Hong Yu, Whitefish Bay, WI (US)

Correspondence Address: BAKER BOTTS L.L.P., 30 ROCKEFELLER PLAZA, 44TH FLOOR, NEW YORK, NY, 10112-4498, US

(21) Appl. No.: 12/139,267

(22) Filed: Jun. 13, 2008

Related U.S. Application Data
(63) Continuation of application No. PCT/US06/62689, filed on Dec. 28, 2006.
(60) Provisional application No. 60/754,380, filed on Dec. 28, 2005.
(60) Provisional application No. 60/779,837, filed on Mar. 7, 2006.

(51) Int. Cl. G06F 17/27

(52) U.S. Cl. 704/9

(57) ABSTRACT

Systems and methods for accessing images with natural language processing are provided. The methods for accessing images include linking an image with image-summarizing text by applying a hierarchical clustering algorithm to cluster one or more abstract sentences and one or more images, and linking an image with image-summarizing text if the abstract sentence belongs to a cluster that includes the image. The systems for accessing images include a natural language processor that applies a hierarchical clustering algorithm to link one or more abstract sentences in an article with one or more images in the article, and a user interface in which selecting image- summarizing text displays one or more linked images.

### CROSS-REFERENCE TO RELATED APPLICATIONS

This application claims the benefit of U.S. Provisional Patent Application Ser. No. 60/754,380, filed on Dec. 28, 2005, entitled “Summarizing Bioscience Full-Text Articles with a Novel User-Interface Design and Natural Language Processing,” and U.S. Provisional Patent Application Ser. No. 60/779,837, filed on Mar. 7, 2006, entitled “BioEx: Accessing Images in Bioscience Literature Through User-Interface Designs and Natural Language Processing,” both of which are hereby incorporated by reference in their entireties herein.

### BACKGROUND OF THE INVENTION

1. Technical Field

The disclosed subject matter relates to information systems and methods for accessing images in articles with natural language processing.

2. Background Information

The rapid growth of electronic publications in science, engineering, and the arts has made it necessary to create information systems that allow researchers to navigate and search efficiently among them. Most of these information systems, however, target text information only and ignore other important data such as images. Images (e.g., figures) are usually key pieces of data in an article (e.g., the evidence of experiments). An image is worth a thousand words. Researchers need to access image data to validate research facts and to formulate or to test novel research hypotheses. For example, a biologist may want to see the image that supports the fact that “a stem cell can generate sebaceous glands.” Additionally, full-text articles are frequently long and typically incorporate multiple images. Researchers often must spend significant amounts of time reading full-text articles in order to access specific images.

In order to facilitate researchers' access to images, online journal publishers have introduced services (e.g., SummaryPlus provided by publisher ScienceDirect), which separately list images and their corresponding captions that appear in full-text articles. FIG. 12 shows a SummaryPlus user interface by which a user can access a listing of individual images in an online article. While this type of separate listing or presentation of individual images in an article may be an improvement over the single-document-per-article presentation format, it does not reflect relationship and contextual information. The separate listing of individual images fails to show connections between images in the article by treating the individual images and captions as if they are disjointed or unrelated. However, images reported in a full-text article are not disjointed. The images are related to each other and, taken as a whole, often lead to the conclusion of the full-text article. Additionally, the associated text (other than image captions) in the full text frequently illuminates the image content.

Accordingly, there is a need in the art for systems and methods that make images in an article easily and readily accessible to readers without loss of relationship or contextual information.

### SUMMARY OF THE INVENTION

Systems and methods for accessing images in articles are disclosed herein. The systems and methods use natural language processing algorithms.

The methods for accessing images include linking an image with image-summarizing text, providing a user with a means for selecting the image-summarizing text, and displaying an image when the image-summarizing text is selected. Natural language processing may be used to link an image with image-summarizing text.

In the natural language processing, an image may be linked with image-summarizing text by applying a hierarchical clustering algorithm to cluster one or more units of image-summarizing text and one or more images, and linking an image with image-summarizing text if the image-summarizing text belongs to a cluster that includes the image.

The image-summarizing text can be displayed and selected through a web-based user interface. The web-based user interface may be based on BioEx or other interfaces in current use.

The hierarchical clustering algorithm used in the natural language processing can be a “term frequency-inverse document frequency” (TF*IDF) weighted cosine coefficient algorithm. The IDFs may be calculated with various types of image-summarizing text, including abstract sentences and image captions, full-text sentences, and/or abstract sentences and image captions separately.

The word features used or assesed by natural language processing may include features such as bag-of-words in image captions, bag-of-words in first sentences of sub-images, and bag-of-words in headings of images and first sentences of sub-images. Additional features used or assesed may be associated text, neighboring sentences, and synonym expansion.

The hierarchical clustering algorithm in natural language processing may use or assess one or more word features and positional charectitics.

The systems for accessing images include a natural language processor that applies a hierarchical clustering algorithm to link one or more units of image-summarizing text in an article with one or more images in the article, and a user interface in which selecting image-summarizing text displays one or more linked images. The hierarchical clustering algorithm may be a TF*IDF weighted cosine coefficient algorithm. One or more IDFs may be calculated with abstract sentences and image captions separately.

### BRIEF DESCRIPTION OF THE DRAWINGS

Further features and advantages of the disclosed subject matter will become apparent from the following detailed description taken in conjunction with the accompanying figures showing illustrative embodiments of the disclosed subject matter, in which:

FIG. 1 is a diagram illustrating the patterns in which abstract sentences are linked to images in full-text articles;

FIG. 2 is a diagram representing a user interface in accordance with an exemplary embodiment of the disclosed subject matter;

FIG. 3 is a diagram illustrating the distribution of linked and unlinked abstract sentences or images as a function of TF*IDF weighted cosine similarity and Dice's coefficient;

FIG. 4 is a diagram illustrating links between abstract sentences and images;

FIG. 5 is a diagram illustrating the recall and precision curve for linking abstract sentences to images in accordance with a first exemplary embodiment of the disclosed subject matter;

FIG. 6 is a diagram illustrating the recall and precision curve for linking abstract sentences to images in accordance with a second exemplary embodiment of the disclosed subject matter;

FIG. 7 is a diagram illustrating the recall and precision curve for linking abstract sentences to images in accordance with a third exemplary embodiment of the disclosed subject matter;

FIG. 8 is a diagram illustrating the recall and precision curve for linking abstract sentences to images in accordance with a fourth exemplary embodiment of the disclosed subject matter;

FIG. 9 is a diagram illustrating the recall and precision curve for linking abstract sentences to images in accordance with a fifth exemplary embodiment of the disclosed subject matter;

FIG. 10 is a diagram illustrating the recall and precision curve for linking abstract sentences to images in accordance with a sixth exemplary embodiment of the disclosed subject matter;

FIG. 11 is a diagram illustrating the recall and precision curve for linking abstract sentences to images in accordance with a seventh exemplary embodiment of the disclosed subject matter;

FIG. 12 is a diagram representing a prior art BioEx user interface.

FIG. 13 is a diagram illustrating a system for accessing images in accordance with an exemplary embodiment of the disclosed subject matter.

### DETAILED DESCRIPTION OF THE INVENTION

Systems and methods for accessing images and image-related textual content in articles are disclosed. The systems and methods employ natural language processing to relate textual content to images in the articles.

In exemplary systems and methods, images in an article are characterized or categorized by image-summarizing text, and/or related textual content in a portion of the article. Image-summarizing text may include many different types of text found in an article or a portion of the article. The abstract of an article may be selected as a suitable portion of the article on the assumption that much of the image data that appear in a full-text article can be summarized by the sentences (“abstract sentences”) in the abstract of the full-text article. Because researchers can read the abstract in order to understand a full-text article, linking abstract sentences to images is an effective and convenient way for researchers to access images.

One way to link image-summarizing text to images is to have the authors of an article to manually associate image-summarizing text with images. It may be feasible for publishers to proscpectively request appropriate annotation when a new manuscript is accepted for publication. However, interesting academic databases have too many historical records to make such a manual approach feasible. For example, PubMed currently has more than 15 million citations. It is not practical to have authors to consistently perform such large-scale annotation.

In a practical manner, the disclosed systems and methods rely on automated natural language processing to link and annotate images with image-summarizing text (e.g., abstract sentences) identified in the article.

An inventive system for accessing images includes a user interface (e.g., a BioEx-based interface) coupled to a natural language processor for processing the articles. In an exemplary embodiment of the system, the natural language processor applies hierarchical clustering algorithms to cluster one or more abstract sentences and one or more images. In another exemplary embodiment, the hierarchical clustering algorithms include TF*IDF weighted cosine coefficient algorithms. The natural language processing algorithms may use or assess various word features, including bag-of-words in image captions, bag-of-words in first sentences of sub-images, and bag-of-words in headings of images and first sentences of sub-images to identify useful image-summarizing text. Additional word features that may be used or assesed include associated text, neighboring sentences, and synonym expansion. The natural language processing algorithms may also take into account word weight by calculating one or more inverse document frequencies (IDFs) using abstract sentences and image captions, using full-text sentences, or using abstract sentences and image captions separately. The natural language processing algorithms may also utilize word features combined with position. Mappings between image-summarizing text and images may be of three types: one-to-one, one-to-many, and many-to-one.

The features of systems and methods of the disclosed subject matter were studied in an investigation of bioscience articles. Details of the investigation have been reported in Hong Yu et al., “Accessing Bioscience Images form Abstract Sentences”, Vol. 22, No. 14, 2006, Hong Yu et al., BioEx: A Novel User-Interface that Acessess Images from Abstract Sentences,” Proc. of Human Language Technology Congerence, pages 189-192, New York, June 2006, and Hong Yu et al. “Towards Answering Questions with Experimental Evidence,” paper prensted at AMIA 2006, all three of which publications are incorprated by refrenence herein in their entireties.

In the reported investigation, a total of 329 recently published biological articles were selected from four journals: Cell (104), EMBO (72), Journal of Biological Chemistry (92), and Proceedings of the National Academy of Sciences (PNAS) (61). For each article, the corresponding author was invited by email to identify abstract sentences that summarize image content in that article. In order to eliminate the errors arising from sentence boundary ambiguity, abstract sentences were manually split and sent as email attachments.

For the investigation, a total of 119 biologists from 19 countries participated voluntarily and identified abstract sentences that summarize figures or tables in their articles. This resulted in a total of 114 annotated articles (39 Cells, 29 EMBO, 30 Journal of Biological Chemistry, and 16 PNAS), a collection that is 34.7% of the total articles requested. The responding biologists included the corresponding authors who had received email requests, as well as the first authors of the articles to whom the corresponding authors had forwarded the email requests. None of the biologists were compensated.

The collection of 114 full-text articles incorporated 742 figures, 75 tables, and 826 abstract sentences. The average number of figures or tables per document was 7.2±1.7 and the average number of sentences per abstract was 7.2±2.0. The data showed that 87.9% of the figures and 85.3% of the tables corresponded to abstract sentences, and 66.5% of the abstract sentences corresponded to images; these statistics empirically validated the premise that image content can be summarized by abstract sentences. Since an abstract is a summary of a full-text article, the results also empirically validated that images are important content in full-text articles.

The total number of tables was a small fraction (10.1%) of the total number of figures. Furthermore, out of the four journals, only EMBO includes tables as images. The total number of table images in the data collection was 15, which represented only 2% of the total image files. Therefore, the study focused only on the 742 figure images.

Three types of links between abstract sentences and images were identified. A one-to-one link was defined as an abstract sentence that is linked to only one image, and that image is linked to only the abstract sentence. A one-to-many link was defined as an abstract sentence that is linked to two or more images. A many-to-one link was defined as an image that is linked to two or more abstract sentences. Table 1 shows the numbers of the three categories in the 114 annotated full-text articles.

TABLE 1

| Type | Number of Links |
|---|---|
| 1:1 | 151 |
| 1:2 | 145 |
| 1:3 | 53 |
| 1:4 | 26 |
| 1:5 | 9 |
| 1:6 | 4 |
| 1:7 | 1 |
| 2:1 | 173 |
| 3:1 | 36 |
| 4:1 | 14 |
| 5:1 | 2 |

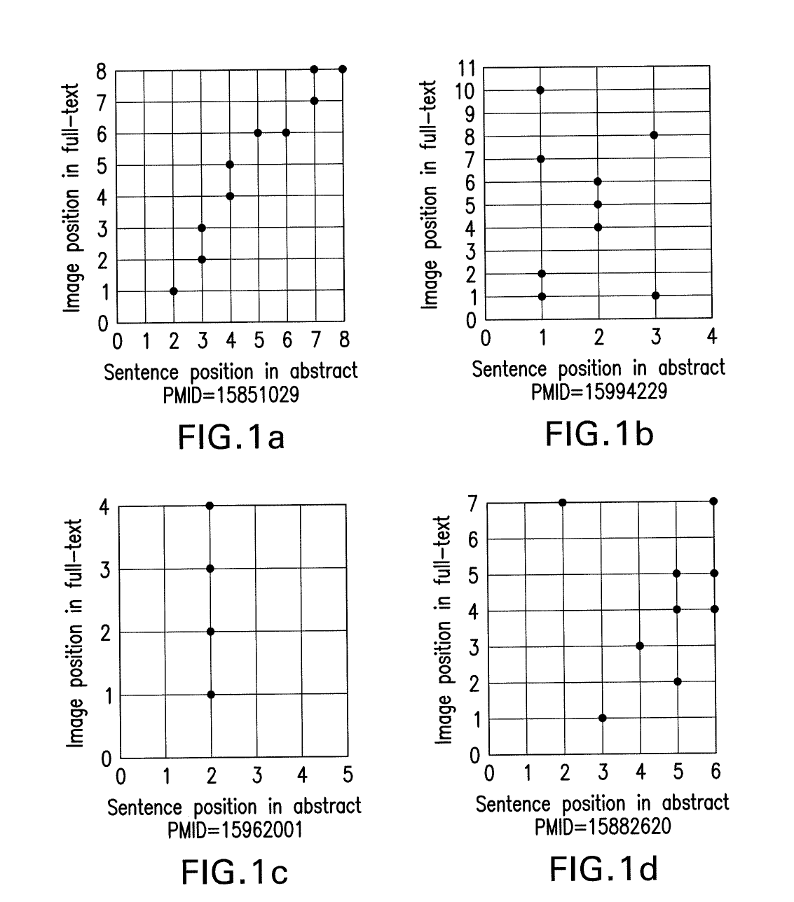

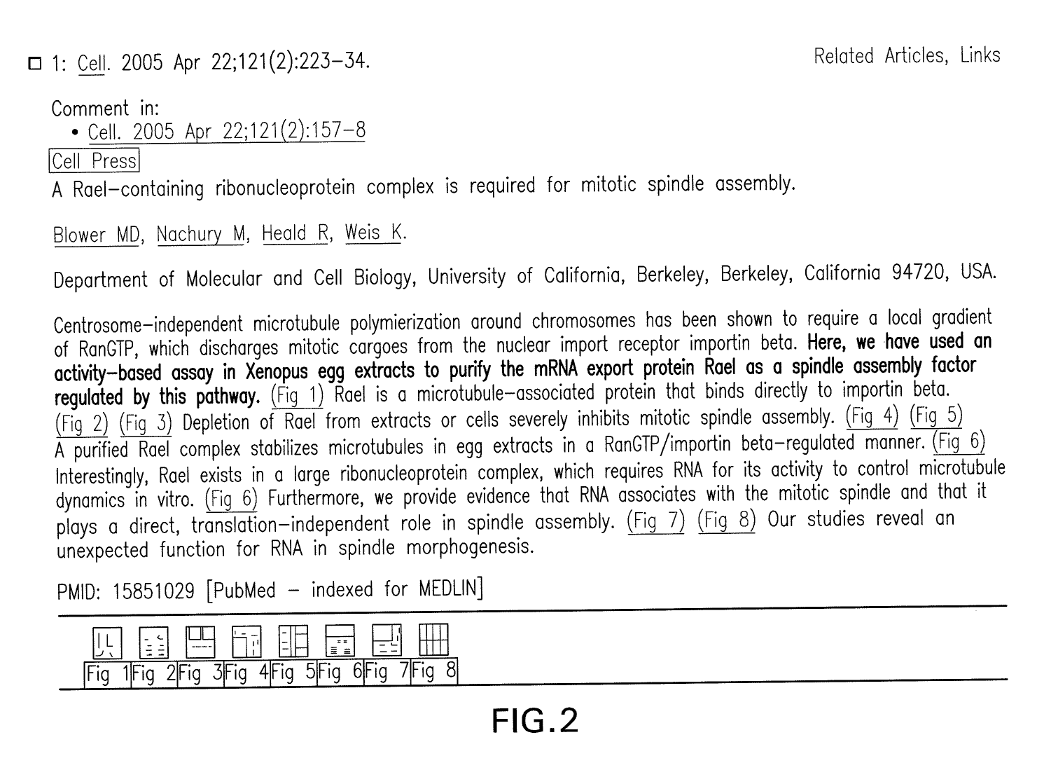

After the annotated articles were examined, the full-text articles were grouped into four link patterns based on the positions in which abstract sentences or images appeared in the abstract or the full-text articles. FIG. 1 illustrates the patterns in which abstract sentences may be linked to images in full-text articles. In FIG. 1A, the abstract sentences are aligned with images in the order they appear in the full-text articles. In FIG. 1B, abstract sentences do not correspond to images in the order they appear in the full-text articles. In FIG. 1C, images are linked to only a few abstract sentences. In FIG. 1D, some abstract sentences align with images in the order they appear in the full-text articles and some do not.

Study participants indicated that 87.9% images in a total of 114 full-text articles can be summarized by abstract sentences. Accessing images by abstract sentences is an improvement over the SummaryPlus user-interface because the former overcomes the disadvantages of disjoint image content and offers an efficient way to access images.

The disclosed systems include suitable user interfaces, which may be based for example, on the BioEx interface available in ScienceDirect. In order to evaluate whether biologists would prefer to accessing images from abstract sentence links, three user interfaces were designed: one based on BioEx, one based on PubMed, and one based on SummaryPlus. As shown in FIG. 2, the BioEx-based user interface was built upon the PubMed user-interface except that images could be accessed by the abstract sentences. The PubMed user-interface design was chosen because it has more than 70 million hits a month and represents the user-interface most familiar to biologists. The two other baseline user-interfaces were the original PubMed user-interface and a modified version of the SummaryPlus user-interface, in which the images were listed as disjointed thumbnails, rather than linked abstract sentences.

The 119 biologists who had linked sentences to images in their articles were asked to assign a label to each of the three user-interfaces. The three label choices were “My favorite,” “My second favorite,” or “My least favorite.” The evaluation was designed so that a user-interface's label was independent of the choices of the other two user-interfaces. A total of 41 or 34.5% of the biologists contacted completed the evaluation. As shown in Table 2, 36 or 87.8% of the total 41 biologists attached the “My favorite” label to the BioEx user interface. One biologist selected “My favorite” for all three user-interfaces. Five other biologists considered SummaryPlus as “My favorite”, two of whom (or 4.9% of the total 41 biologists) judged BioEx to be “My least favorite”. The SummaryPlus user-interface was the second choice by a majority of biologists (63.4%).

TABLE 2

| | Favorite | Second Favorite | Least Favorite |
|---|---|---|---|
| PubMed | 1 | 11 | 29 |
| SummaryPlus | 6 | 26 | 9 |
| BioEx | 36 | 3 | 2 |

One way to implement an abstract sentence-based user interface is to ask the authors of a paper to link abstract sentences to images. However, because article databases may contain millions of citations, it may not be feasible to ask the authors to perform such large-scale of annotation. Linking abstract sentences to images may be performed by aligning abstract sentences to other associated texts (i.e., captions and other embedded text) that correspond to the same images. Such simplification is based on two assumptions. The first is that image content consistently corresponds to its associated text in the full-text articles.

The second assumption is that there are strong word similarities between abstract sentences and other associated texts. To validate this assumption, the link distribution was plotted as a function of word similarity using the 114 annotated full-text articles. Two similarity measures were examined, namely, Dice's coefficient and the TF*IDF weighted cosine coefficient, both of which are commonly used in tasks including information retrieval and topic detection. Dice score D(i, j) was calculated by formula (1):

$$D ( i , j ) = \frac{2 {W}_{ij}}{{W}_{i} + {W}_{j}}$$

The TF*IDF weighted cosine coefficient score sim(i, j) was calculated by formula (2):

$$idf ( w ) = {log}_{10} ( \frac{N}{N ( w )} )$$

and formula (3):

$$sim ( i , j ) = \frac{{\sum }_{w = 1}^{{W}_{i} ⋃ {W}_{j}} [ {tf}_{i} ( w ) * idf ( w ) ] * [ {tf}_{j} ( w ) * idf ( w ) ]}{\sqrt{{\sum }_{w = 1}^{{W}_{i}} {tf}_{i}^{2} ( w )} * \sqrt{{\sum }_{w = 1}^{{W}_{i}} {tf}_{j}^{2} ( w )}}$$

Wᵢ and Wⱼ are the total words in texts i and j, where i and j are either abstract sentences or image captions. In formulas (2) and (3), inverse document frequency (IDF) of a word is calculated from all sentences (N) in the full-text article.

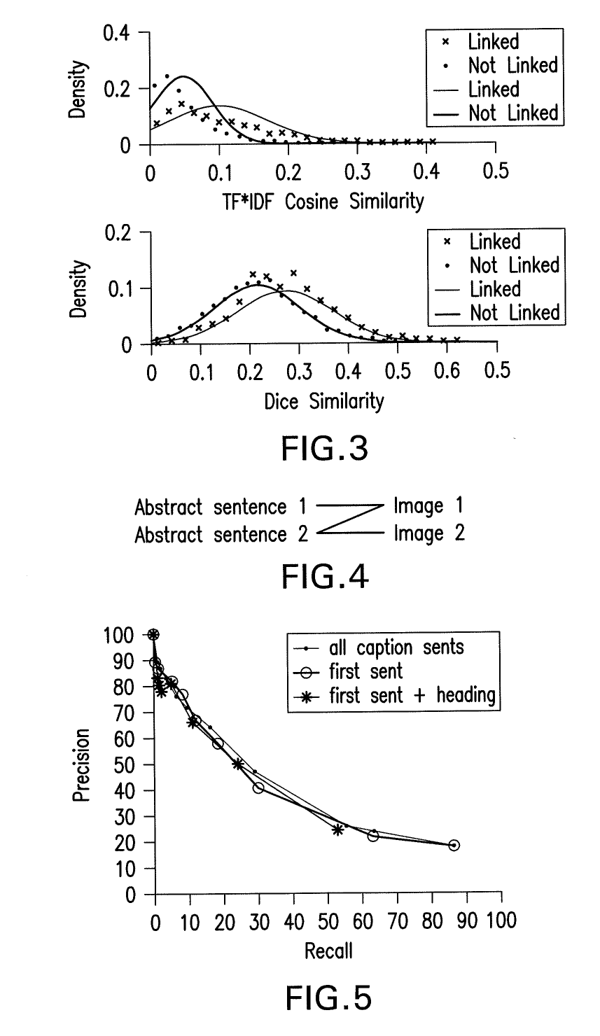

As illustrated in FIG. 3, both TF*IDF weighted cosine similarity and Dice score can separate linked pairs from unlinked pairs and the TF*IDF weighted cosine similarity shows an advantage over the Dice's score for separating linked pairs from unlinked pairs. The results empirically validate the assumption that there are word similarities between abstract sentences and their corresponding image captions.

The inventive systems and methods may utilize different models for mapping abstract sentences to images. For example, linking abstract sentences to image captions and other associated text may be treated as a task of sentence alignment in machine translation. In machine translation, most of the sentences are aligned and typically a majority of sentences are aligned one-to-one (i.e., one sentence is translated to only one sentence in the second language). However, in the investigation as illustrated in Table 1, many abstract sentences and images do not have any corresponding images or sentences and many abstract sentences and images correspond to two or more images and abstract sentences.

Furthermore, techniques that are successful in machine translation for text might not be succesful in the task of linking abstract sentences to images. For example, sentence length (i.e., a long sentence must be translated to a long sentence in another language) was found to be powerful factor in sentence alignment. However, in the investigation there was no evidence of a direct correspondence between the length of an abstract sentence and the length of the corresponding image caption. Additionally, in machine translation, most sentences are aligned in the order they appear. However, as illustrated in FIG. 1B-D, orderly alignment does not apply to many cases in the data collection used in the investigation.

To overcome these difficulties, the natural language processing may be based on a model that applies hierarchical clustering algorithms to cluster abstract sentences and images based on word similarities. As shown in FIG. 3, in the investigations this model was able to separate linked abstract image pairs from unlinked ones. In one exemplary embodiment, if abstract sentences belong to the same cluster that includes images, the abstract sentences are deemed to summarize the image content. The clustering model allows “one-to-many” and “many-to-one” mapping and facilitates incorporating positional information.

Hierarchical clustering algorithms are well-established algorithms that are widely used in many other research areas including biological sequence alignment, gene expression analyses, and topic detection. The algorithm starts with a set of text (i.e., abstract sentences or image captions). Each sentence or image caption represents a document that needs to be clustered. The algorithm identifies pair-wise document similarity and then merges the two documents with the highest similarity into one cluster. It then re-evaluates pairs of documents/clusters; two clusters can be merged if the average similarity across all pairs of documents within the two clusters exceeds a predefined threshold. In presence of multiple clusters that can be merged at any time, the pair of clusters with the highest similarity is always preferred. In the investigation, pairwise document similarity was calculated based on the TF*IDF weighted cosine similarity because the TF*IDF method had previously been shown to have an advantage over the Dice method (FIG. 3). In addition, different word features, weights, positional information, and clustering strategies were explored.

Further in the investigation, bag-of-words and n-grams were explored as word features for the clustering tasks. Additionally, different feature combinations were examined, including features in the caption, other associated text, neighboring text, and synonyms.

An image caption usually incorporates multiple sentences or phrases. The heading usually provides an abstraction of the entire image content, and the first sentence of each subheading provides a summary of each subexperiment reported in an article. Combinations of the heading and the first sentences of the subheading were explored in the investigation, including 1) all words in the caption, 2) the heading plus the first sentence of each sub-experiment in the image caption, and 3) the first sentence of each sub-experiment.

The image caption is not the only content that describes the experiment reported in the article. There is other associated text in the full-text article document that may provide additional discriminating features for clustering. “Other associated text” was identified by surface cues. Paragraphs incorporating “Figure X” were extracted from the full-text article. These paragraphs were then merged with the corresponding image captions. The merged text was then subjected to the clustering procedure. This approach stems from the fact that biologists frequently devote an entire paragraph or more to describing the results of one experiment.

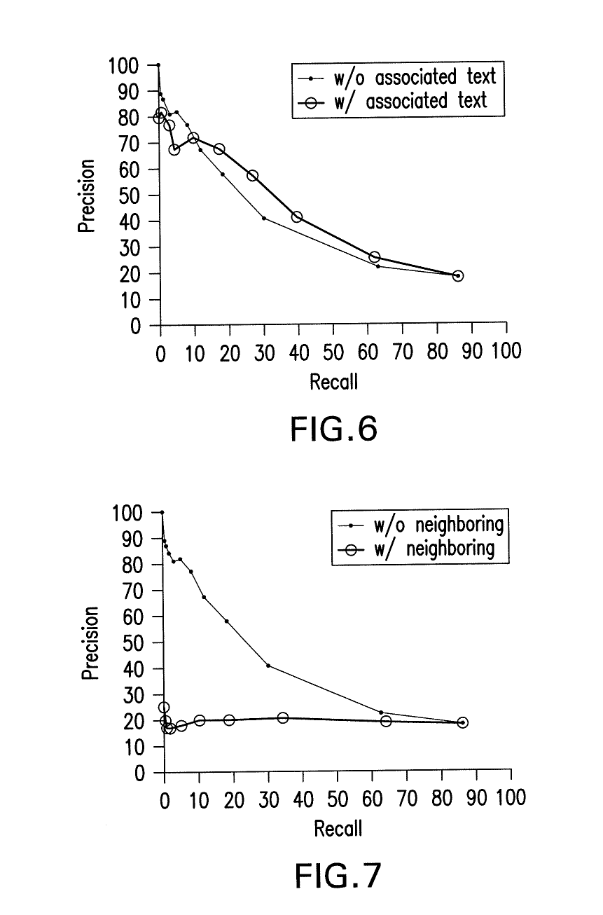

Abstract sentences are coherent and the neighboring sentences (the preceding and the following sentences) may be content-related. Furthermore, 135 out of the total 746 images or 18% images in the data collection in the investigation corresponded to consecutive abstract sentences. For example, FIG. 1A shows that the two abstract sentences “a purified Rael complex stabilizes microtubules in egg extracts in a RanGTP/importin beta-regulated manner” and “interestingly, Rael exists in a large ribonucleoprotein complex, which requires RNA for its activity to control microtubule dynamics in vitro” point to the same image “FIG. 6”. “Neighboring text” was therefore explored as an additional feature. The features of the neighboring abstract sentences, namely, the previous and the following sentences, were merged with the abstract sentence to be examined. The merged features were then used to identify images that were associated with the abstract sentence.

Abstract sentences and image captions do not always use the exact same words. Synonym expansion may enhance the clustering performance. The large biomedical knowledge resource the Unified Medical Language System (UMLS) was applied to expand synonyms. The UMLS incorporates more than one million biomedical concepts with synonyms. Simple string matching was used to capture the terms and to map terms to the UMLS concepts and synonyms.

For document clustering, the TF*IDF weighted cosine similarity was applied. Each sentence or image caption was treated as a “document” and the features were bag-of-words. Three different methods were explored to obtain the TF*IDF value for each word feature:

(1) IDF (abstract+caption)—the IDF values were calculated from the pool of abstract sentences and image captions;

(2) IDF (full-text)—the IDF values were calculated from all sentences in the full-text article;

(3) IDF (abstract) +IDF (caption)—two sets of IDF values were obtained. For words that appeared in abstracts, the IDF values were calculated from the abstract sentences; for words that appeared in image captions, the IDF values were calculated from the image captions.

Although in many of the annotated full-text articles the abstract sentences do not correspond to images in the order they appear in the full-text articles, the chance that two abstract sentences or images link to an image or an abstract sentence decreases when the distance between two abstract sentences or images increases. For example, two consecutive abstract sentences have a higher probability to link to one image than two abstract sentences that are far apart. Such “positional distance” also applies to images: two consecutive images have a higher chance to link to the same abstract sentence than two images that are separated by many other images. To integrate such positional information into the existing hierarchical clustering algorithms, the TF*IDF weighted cosine similarity was modified to take into account positional distance. Assuming that abstract sentences or image captions are considered documents and the TF*IDF weighted cosine similarity for a pair of documents i and j is sim(i,j), integrating the positional distance yields the final similarity SIM(i,j) in formula (4):

$$S I M ( i , j ) = sim ( i , j ) * ( 1 - abs ( \frac{{P}_{i}}{{T}_{i}} - \frac{{P}_{j}}{{T}_{j}} ) )$$

If i and j are both abstract sentences, Tᵢ=Tⱼ=total number of abstract sentences; and Pᵢ and Pⱼ represent the positions of sentences i and j in the abstract.

If i and j are both image captions, Tᵢ=Tⱼ=total number of images that appear in a full-text article; and Pᵢ and Pⱼ represent the positions of images i and j in the full-text article.

If i and j are an abstract sentence and an image caption, respectively, Tᵢ=total number of abstract sentences and Tⱼ=total number of images that appear in a full-text article; and Pᵢ and Pⱼ represent the positions of abstract sentence i and image j.

Although there are many word similarities between abstract sentences and their corresponding image captions, there are also significant differences between the two texts. In general, image captions tend to be long and incorporate content-lean experimental details. To best capture the differences between abstract sentences and image captions, three clustering strategies were explored; namely, per-image, per-abstract sentence, and mix.

The per-image strategy clusters each image caption with all abstract sentences. The image is assigned to (an) abstract sentence(s) if they belong to the same cluster. This method values features in abstract sentences more than image captions because the decision that an image belongs to (a) sentence(s) depends upon the features from all abstract sentences and the examined image caption. The features from other image captions will not play a role for the clustering.

The per-abstract-sentence strategy takes each abstract sentence and clusters it with all image captions that appear in a full-text article. Images are assigned to the sentence if they belong to the same cluster. This method values features in image captions higher than the features in abstract sentences because the decision that an abstract sentence belongs to image(s) depends upon the features from the image captions and the examined abstract sentence. The features from other abstract sentences will not play a role for the clustering.

The mix strategy (Mix) clusters all image captions with all abstract sentences. This method treats features in abstract sentences and image captions equally.

In addition, because the clusters generated by the hierarchical clustering algorithms are typically mutually exclusive, Mix will never achieve 100% accuracy for detecting the links illustrated in FIG. 4. If grouping into four clusters, Mix will create three false negatives. If grouping into three clusters, Mix will create at least two false negatives. If grouping into two clusters, Mix will create one false negative. If grouping into one cluster, Mix will create one false positive.

The 114 bioscience articles described previously were used to evaluate the mapping between abstract sentences and images. Recall and precision are reported as the evaluation metrics for linking sentences to images. Recall is the total number of correctly predicted links divided by the total number of annotated links. Precision is the total number of correctly predicted links divided by the total number of predicted links.

FIGS. 5-11 illustrate the results in which different combinations of features and algorithms were explored. The default parameters for all these experiments were “per image”, “without UMLS synonyms”, “bag-of-words”, and “IDF(abstract+caption)”, “without neighboring sentences” and “without position”.

FIG. 5 illustrates the recall and precision curve for linking abstract sentences to images in which the features are bag-of-words in 1) image captions, 2) the combined heading with the first sentence from each sub-experiment, and 3) the first sentence from each sub-experiment. The results show that incorporating all image captions as features leads to a slightly better performance over the other features.

FIG. 6 illustrates that the clustering performance increases when features include other associated text. The results directly support the assumptions that other associated text represents image content and that there are lexical similarities between abstract sentence and other associated text that correspond to an image. Because the feature spaces have been expanded, the overall recall and precision have increased. On the other hand, the high-end precision has dropped from 100% to 80%. This can be explained by the fact that although other associated text may incorporate useful word features that do not appear in captions, they may also include words that never appear in the corresponding abstract sentences, and those words introduce “noise” at the clustering. Additionally, a simple approach was implemented for identifying other associated text: the entire paragraph was identified as the “other associated text” if the paragraph contained the surface cue “Figure X”. This approach introduces significant “noise” because frequently, a paragraph may describe more than one experiment.

FIG. 7 shows that “without neighboring sentences” greatly outperformed “with neighboring”. The results indicate that the useful information introduced by the neighboring sentences is overshadowed by noise. The results are not entirely surprising. Although 18% images in the data collection correspond to consecutive abstract sentences, a majority of images do not. Specifically, 424 (57.1%) images correspond to single abstract sentences, 91 (12.3%) images correspond to non-consecutive abstract sentences, and 92 (12.4%) images do not link to any of the abstract sentences.

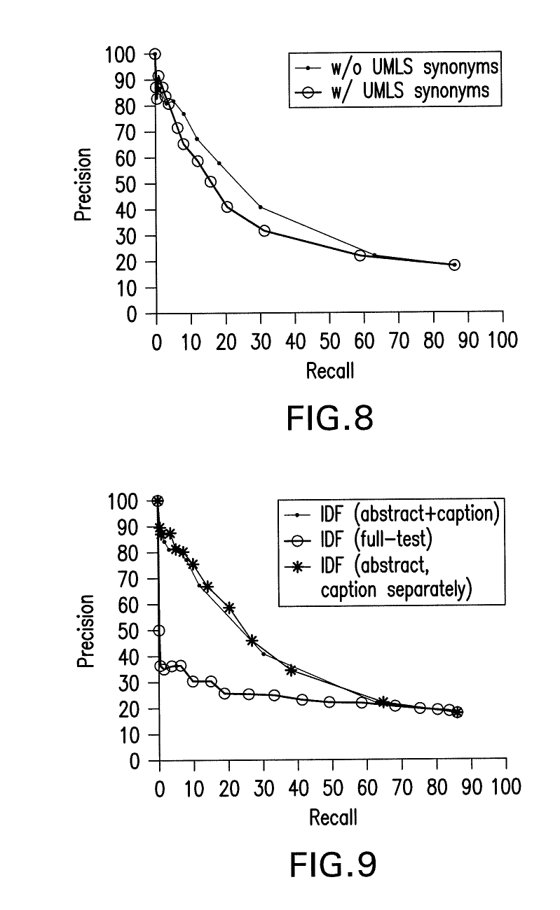

FIG. 8 illustrates that synonym expansion does not improve performance. Several factors, may have contributed to these results, including how robust the mapping was between a string and the UMLS concepts and the problems associated with homonyms.

FIG. 9 shows the performance of three different methods for calculating the IDF values. The results show that the “global” IDFs, or the IDFs obtained from the full-text article, do not perform as well as “local” IDFs, or IDFs calculated from the abstract sentences and image captions. The results suggest that abstract sentences and image captions alone are more accurate than the whole fill-text article for estimating the importance of features when linking abstract sentences to image captions. In addition, IDFs that were separately calculated from the abstract sentences and image captions perform slightly better than the combined IDFs. The results suggest that the distributions of features are different for abstract sentences and image captions.

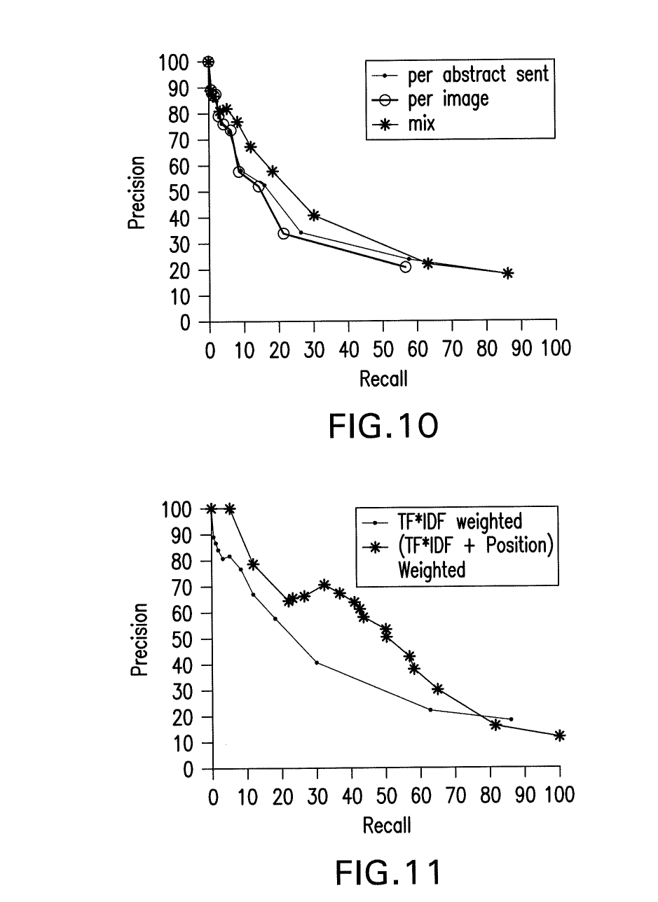

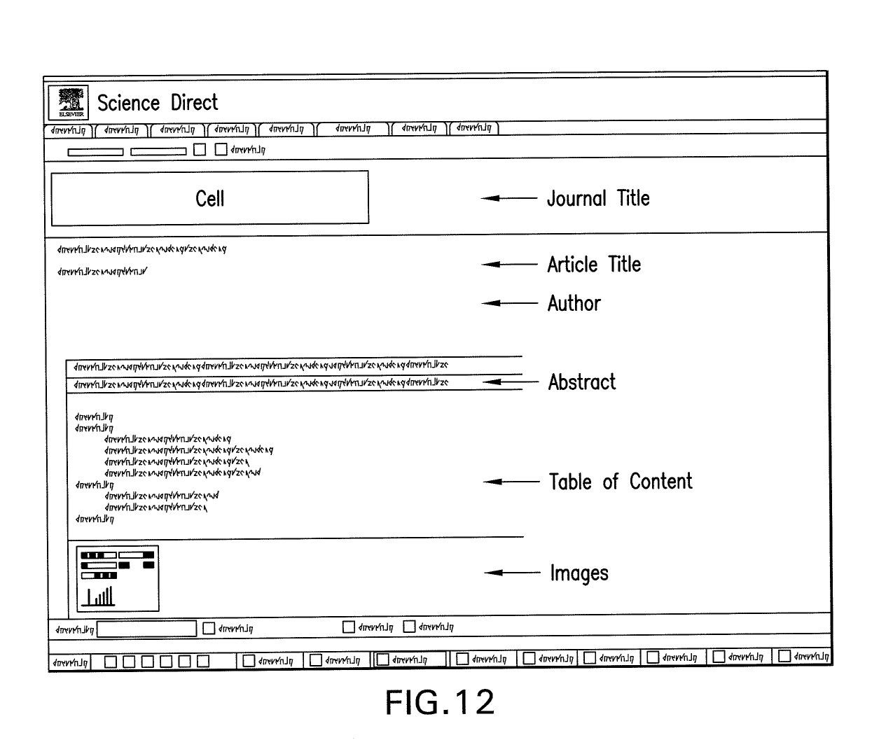

Three strategies were explored for linking abstract sentences to images; namely, Per-image that takes each image caption and clusters it with abstract sentences, Per-abstract-sentence that takes each abstract sentence and clusters it with image captions, and Mix that clusters all image captions with all abstract sentences. FIG. 10 illustrates that both Per-image and Per-abstract-sentence out-perform Mix. Furthermore, Per-image significantly outperforms Per-abstract-sentence. The results suggest that features in abstract sentences are more useful than features in captions for the task of clustering.

FIG. 11 illustrates that combining word features with position significantly enhances performance. When the recall is 33%, the precision of combining TF*IDF with positional information increases to 72% from the original 38%, which corresponds to a 34% absolute increase. The results strongly indicate the importance of positional information. When the precision is 100%, the recall is 4.6%. High precision is important, but low recall prevents effective searching. In order to improve overall performance, BioEx was implemented with a recall of 33% and a precision of 72% from which a user can query 17,000 downloaded full-text Proceedings of the National Academy of Sciences (PNAS) full-text articles.

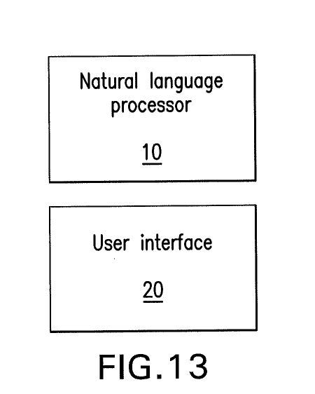

FIG. 13 illustrates a system for accessing images that includes a natural language processor 10 that applies a hierarchical clustering algorithm to link one or more units of image-summarizing text in an article with one or more images in the article, and a user interface 20 in which selecting image-summarizing text displays one or more linked images.

The evaluation data consisted of three types of mappings between abstract sentences and images: one-to-one, one-to-many, and many-to-one. Previous dynamic programming methods in machine translation had showed significant decreases in performance when a sentence was aligned to multiple sentences. Therefore, the performance of our algorithms for each type was examined. The precision for this task could not be measured because the false positives for each type were missed. Instead, the recall for different types of mapping were compared. The system with the overall F-score of 44.4% was selected. The results did not show significant differences in recall among three types of mapping. The results indicate that hierarchical clustering methods may be more robust than dynamic programming methods.

It will be understood that the foregoing is only illustrative of the principles of the disclosed subject matter, and that various modifications can be made by those skilled in the art without departing from the scope and spirit of the disclosed subject matter as defined by the appended claims. Exemplary embodiments may be combined with other exemplary embodiments or modified to create new embodiments.

We claim:

1. A method for accessing images comprising:
linking an image with image-summarizing text;
providing a means for selecting said abstract sentence; and
displaying said image when said abstract sentence is selected.

2. A method according to claim 1, wherein linking an image with image-summarizing text comprises using natural language processing to link an image with image-summarizing text.

3. A method according to claim 1, wherein linking an image with image-summarizing text comprises:
applying a hierarchical clustering algorithm to cluster one or more image-summarizing text units and one or more images; and
linking an image with an image-summarizing text unit if said image-summarizing text unit belongs to a cluster that includes said image.

4. A method according to claim 1, wherein providing a means for selecting said image-summarizing text unit comprises displaying said image-summarizing text unit through a web-based user interface.

5. A method according to claim 1, wherein providing a means for selecting said image-summarizing text unit comprises displaying said image-summarizing text unit through a BioEx user interface.

6. A method according to claim 3, wherein said hierarchical clustering algorithm comprises a TF*IDF weighted cosine coefficient algorithm.

7. A method according to claim 3, wherein features comprise bag-of-words in image captions.

8. A method according to claim 3, wherein features comprise bag-of-words in first sentences of sub-images.

9. A method according to claim 3, wherein features comprise bag-of-words in headings of images and first sentences of sub-images.

10. A method according to claim 3, wherein features comprise associated text.

11. A method according to claim 3, wherein features comprise neighboring sentences.

12. A method according to claim 3, wherein features comprise synonym expansion.

13. A method according to claim 3, wherein one or more IDFs is calculated with abstract sentences and image captions.

14. A method according to claim 3, wherein one or more IDFs is calculated with full-text sentences.

15. A method according to claim 3, wherein one or more IDFs is calculated with abstract sentences and image captions separately.

16. A method according to claim 3, wherein said hierarchical clustering algorithm comprises one or more word features and position.

17. A system for accessing images comprising:
a natural language processor that applies a hierarchical clustering algorithm to link one or more image-summarizing text units in an article with one or more images in said article; and
a user interface wherein selecting an image-summarizing text unit displays one or more linked images.

18. A system according to claim 17, wherein the hierarchical clustering algorithm comprises a TF*IDF weighted cosine coefficient algorithm.

19. A system according to claim 18, wherein one or more IDFs is calculated with abstract sentences and image captions separately.

20. A system according to claim 18, wherein said hierarchical clustering algorithm comprises one or more word features and position.
